(19) United States
(12) Patent Application Publication
(10) Pub. No.: US 2011/0174940 A1
(43) Pub. Date: Jul. 21, 2011

(54) Hook for hanging object on a wall

(76) Inventor: Edward Cai, Camas, WA (US)

(21) Appl. No.: 12/657,485

(22) Filed: Jan. 21, 2010

(51) Int. Cl. F16B 47/00; F16M 13/02

(52) U.S. Cl. 248/205.3; 248/205.1

(57) ABSTRACT

A hook for hanging objects comprises a first plate for mounting to a wall, a holder and a distributor having a second plate and a thin gap between the plates for dissipating the object's weight to prevent the hook from falling off the wall. The holder has a first opening to receive a wine glass, second opening to allow the stem of the wine glass to enter the first opening and third opening for stabilizing the wine glass. The wine glass may deform the second plate, which acts as a weight watcher to indicate on a mark plate whether the wine glass is overweight, thereby further preventing any accidental falling off the hook, thus the wine glass, from the wall.

### FIELD OF THE INVENTION

This invention relates to a hook for hanging objects on a wall or other support surface.

### BACKGROUND OF THE INVENTION

Hooks are well known in the art, and there are hundreds of hooks commercially available. Such hooks typically have a mounting plate with adhesive or sharp member (e.g. nails or screws) to attach to the wall and an outward protrusion on the mounting plate. The objects usually have a hole or loop to hang over the protrusion.

Existing hooks, especially hooks attached to the wall by adhesive, sometimes fall off the wall and cause damage to the object hung thereon. Although hook manufacturers normally specify the maximum weight for the object, many consumers are not good at estimating weight. In addition, existing hooks cannot hang objects, such as wine glasses, that do not have a through hole or loop, unless one is willing to buy one of the expensive and difficult to install wine racks or the like. In addition, current hooks are designed to hang only one object, though expensive and difficult-to-mount racks with two or more hooks are available. The present invention intends to provide a hook to resolve these problems.

### SUMMARY OF THE INVENTION

In accordance with the present invention, there is provided a hook comprising a base plate for mounting to a cabinet or countertop wall, a holder having a first opening to receive the stem of a wine glass and a second opening to allow the stem to enter the first opening, and a distributor connected to the base plate and to an extension beam of the holder to distribute or dissipate the object's weight to prevent the hook, thus the wine glass, from falling off the wall. The first opening of the holder is larger than the stem but smaller than the base or containing chamber of the wine glass, and the second opening is smaller than the stem to prevent the wine glass from accidently falling out and expandable to enable the stem to be pushed into the first opening. The extension beam may be adapted to extend away from the base plate when the wine glass is large and to be pushed in when the wine glass is small. The holder may further have a third opening below the first opening for stabilizing the wine glass and a forth opening to allow the stem to enter the third opening. The second and forth openings may be un-aligned so that the stem cannot move out of the first and third openings vertically, thereby further preventing the wine glass from falling out of the hook.

The distributor comprises a distribution plate, a thin gap between the distribution plate and base plate, and a bottom chamber defined by a short right and left side walls. The hook may comprise additional holders on the distribution plate, and may further have an extension plate connected to the distribution plate with a plurality of holders connected to the underside of the extension plate. The bottom chamber of the distributor may be sufficiently wide to receive or hang objects such as spoons, knives and phones that do not have a through hole or loop to fit to a conventional hook. The chamber may be expandable to receive various sizes of object and clamp the object.

When the wine glass was heavy, the distribution plate tends to tilt and the thin gap enlarges. When the thin gap becomes too large, the hook, thus the wine glass, may fall off the wall. As a result, another aspect of the invention includes a weight watcher having a mark plate with marks to show the degree of the tilting of the distribution plate, thus indicating whether the wine glass is overweight. Alternatively, the weight watcher may have a spring between a lower and upper distribution plate and a normally hidden red mark that becomes exposed when the wine glass to heavy enough to compress the spring sufficiently. The weight watcher may also be an arc-shaped distribution plate that bends downward by the wine glass to indicate the weight of the wine glass on a mark plate.

It is an object of the present invention to provide a hook that is much less prone to fall off the support wall.

It is a further object of the present invention to provide a hook to hang easy-to-break items such as wine glasses securely.

It is a further object of the present invention to provide a hook having a mechanism to warn the user when the object hung on the hook is overweight.

It is a further object of the present invention to provide a hook that can show the user the actual weight of the object hung on the hook.

These and other objectives and advantages of the present invention will become apparent from the following description of the preferred embodiments, taken together with the accompanying drawings.

### DESCRIPTION OF THE DRAWING

The accompanying drawing illustrates diagrammatically non-limitative embodiment of the invention, as follows:

FIG. 1 is a sectional view of a new hook according to a first preferred embodiment;

FIG. 1A is a sectional view of the new hook of FIG. 1 along a cross section A-A;

FIG. 1B is a sectional view of the new hook of FIG. 1 along a cross section B-B;

FIG. 1C is a sectional view of the new hook of FIG. 1 along a cross section C-C;

FIG. 2 is a perspective view showing the use of the hook of FIG. 1 to hang wine glasses in a kitchen cabinet;

FIG. 3 is a sectional view of a new hook according to a second preferred embodiment;

FIG. 3A is a sectional view of the new hook of FIG. 3 along a cross section A-A;

FIG. 3B is a sectional view of the new hook of FIG. 3 along a cross section B-B;

FIG. 3C is a top view of the new hook of FIG. 3 along a cross section C-C;

FIG. 4 is a sectional view of a new hook according to a third preferred embodiment

FIG. 5 is a sectional view of a new hook according to a forth preferred embodiment;

FIG. 6 is a sectional view of a new hook according to a fifth preferred embodiment;

FIG. 7 is a sectional view of a new hook according to a sixth preferred embodiment;

FIG. 8 is a sectional view of a new hook according to a seventh preferred embodiment;

FIG. 8A is a sectional view of the new hook of FIG. 8 along a cross section A-A;

FIG. 8B is a sectional view of the new hook of FIG. 8 along a cross section B-B;

FIG. 8C is a sectional view of the new hook of FIG. 8 along a cross section C-C;

FIG. 9 is a sectional view of a new hook according to an eighth preferred embodiment

FIG. 10 is a sectional view of a new hook according to a ninth preferred embodiment;

FIG. 10A is a sectional view of the new hook of FIG. 10 along a cross section A-A;

FIG. 10B is a sectional view of the new hook of FIG. 10 along a cross section B-B;

FIG. 10 is a partly sectional and partly perspective view showing the use of the hook of FIG. 10 to hang three different items on one hook;

FIG. 11 is a sectional view of a new hook according to a tenth preferred embodiment;

FIG. 11A is a sectional view of the new hook of FIG. 11 along a cross section A-A;

FIG. 11B is a sectional view of the new hook of FIG. 11 along a cross section B-B;

FIG. 12 is a sectional view of a new hook according to an eleventh preferred embodiment;

FIG. 12A is a sectional view of the new hook of FIG. 12 along a cross section A-A;

FIG. 12B is a sectional view of the new hook of FIG. 12 along a cross section B-B;

FIG. 13 is a sectional view of a new hook according to a twelfth preferred embodiment;

FIG. 14 is a perspective view of a new hook according to a thirteenth preferred embodiment;

FIG. 15 is a perspective view of a new hook according to a fourteenth preferred embodiment;

FIG. 16 is a perspective view of a new hook according to a fifteenth preferred embodiment;

FIG. 17 is a perspective view of a new hook according to a sixteenth preferred embodiment;

FIG. 17A is a perspective view of the hook of FIG. 17 used to hang a wine glass;

FIG. 17B is a perspective view of the hook of FIG. 17 used to hang a glass of wine;

FIG. 17C is a perspective view of the hook of FIG. 17 used to hang a juice glass.

### DETAILED DESCRIPTION OF THE PREFERRED EMBODIMENTS

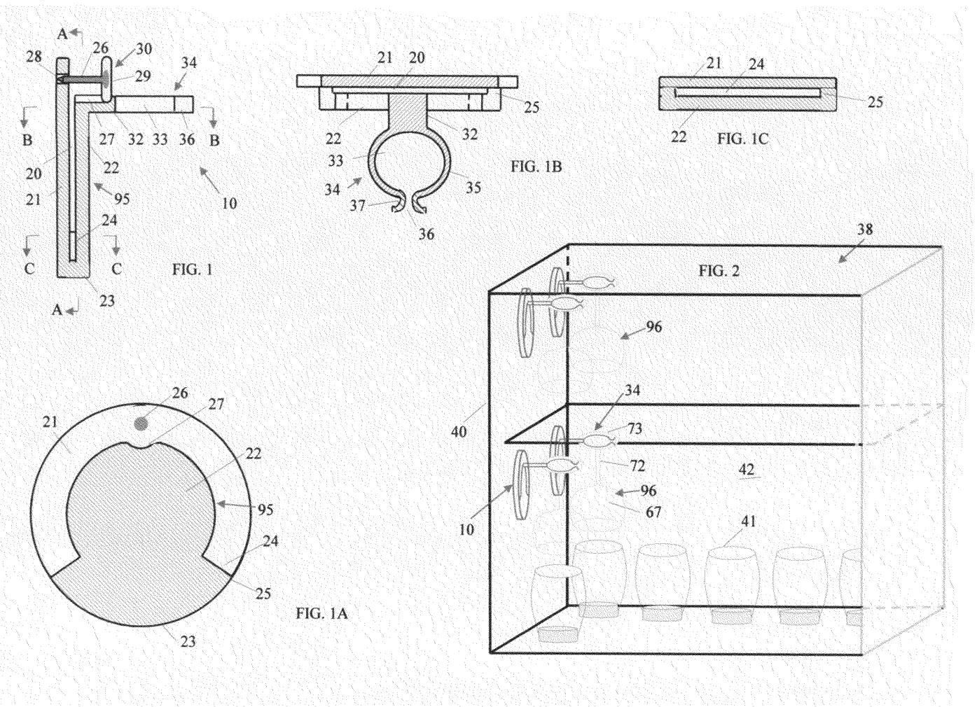

FIGS. 1 to 1C show a new hook 10 that comprises a base plate 21 having a front surface facing the object to be hung, a back surface for engagement with a support surface such as a cabinet or countertop wall 42 (FIG. 2), a holder 34 for holding the object such as a wine glass 96, and a distributor 95 to distribute the force produced by the weight of the object over the base plate, therefore minimizing the risk of disengagement between the base plate and the support surface as a result of the object's weight.

The base plate has a small opening 28 to receive the sharp tip of the needle 26 on the attaching member 30 that has cap 29 housed in a track 27 formed on the top end of the distributor. The track 27 guides the penetration of the support wall by the needle 26 during mounting. The track 27 can also be formed on the base plate 21. The distributor 95 has near its top end an extension plate or beam 32 connected to the left end of the holder 34. The holder has at its right end a first opening 33 to receive the stem 72 of a wine glass 96 (FIG. 2) and a second opening 36 to allow the stem 72 of the wine glass to enter the first opening 33. The first opening is formed by a left and right side arc-shaped beams 35, and substantially larger than the stem 72 but smaller than at least one of the glass base 73 and wine containing chamber 67 of the wine glass 96. The second opening 36 is formed between the left and right extensions 37 of the left and right arc-shaped beams 35, respectfully. The second opening is preferably smaller than the stem 72 to prevent the wine glass from accidently falling out, and is sufficiently expandable to enable the stem 72 to be pushed into the first opening 33 manually.

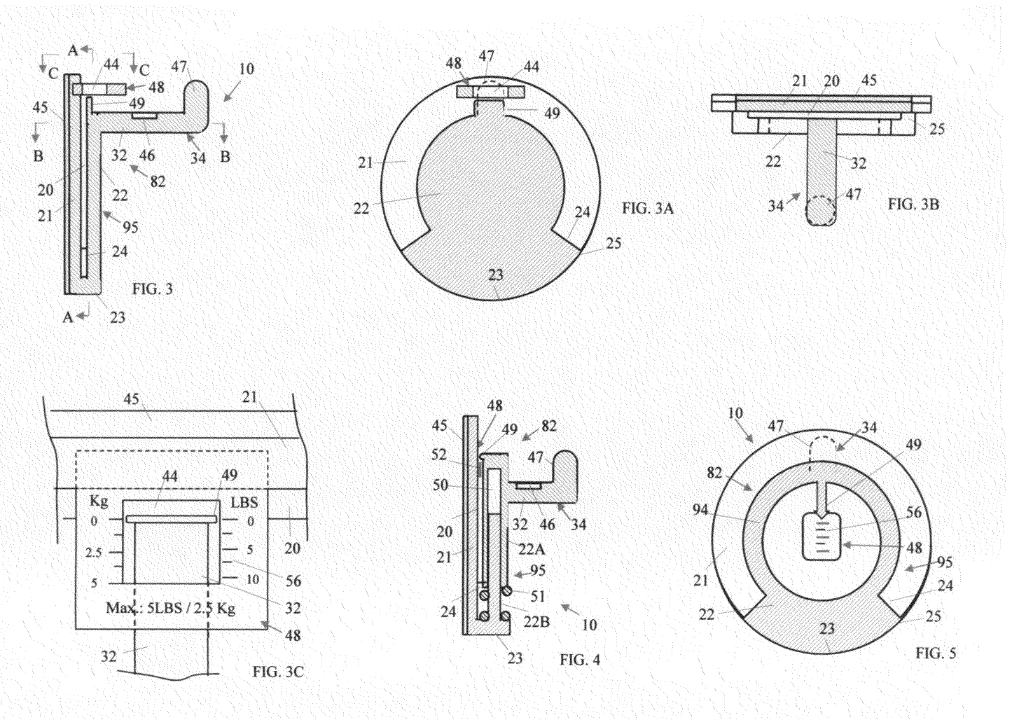

Wine glasses are very susceptible to breakage if the hook 10 falls off the support surface 40 (FIG. 2). The distributor 95 was found to be able to prevent such accidental falling off even if the attaching member 30 is replaced by less reliable pressure sensitive adhesive 45 (FIG. 3). The distributor is connected to the lower end of the base plate near its bottom 23, and comprises a distribution plate 22 and a thin gap 20 separating the plate 22 from base plate 21. The distribution plate 22 extends upwards with its upper end connected to the extension plate 20 and subsequently to the holder 34, therefore allowing the holder to hold the wine glasses at a higher position on the support wall and create more space between the wine glasses and the bottom end of the support wall. This helps create storage space below the hung wine glasses to enable other items like juice glasses, mugs and bowls to store below the wine glasses on the countertop or cabinet (FIG. 2).

The gap 20 is sufficiently thin to prevent the object or part of the object, such a hanging loop or hole of an object to be hung in FIG. 3, from entering the gap. Thin gap 20 is also found to distribute and dissipate the weight of the object, thus preventing any accidental falling off of the hook from the wall 40. The gap should normally be less than 0.5″, preferably less than 0.1″, and most preferably less 0.05″ wide. The distribution plate can be replaced by a distribution beam, arc or other rigid structural member. The distributor may also have a bottom chamber 24 defined by the plates 21 and 22, the right and left side walls 25 and bottom 23. It was found that the height of the side wall 25 should be short for the distributor 95 to dissipate the weight of the object and prevent the accidental falling off the hook. The height of the side wall is normally less than two thirds the height of the plate 22, preferably less than one quarter the height of the plate 22. It is appreciated that the distribution plate 22 can be larger than the base plate 21 (not shown), and the base plate and distribution plate can be plastic, metal, wood or ceramic, and may adopt any shape such as oval, round, rectangular or square shape.

It was discovered that when a heavy wine glass is hung on the hook 10, the distribution plate 22 tilted towards the left and the gap 20 became larger. It was also found that when the gap 20 became substantially larger than the original gap, the hook had a much higher probability to fall off the support wall, especially in the case that the attachment member 30 was replaced by pressure sensitive adhesive. FIGS. 3-3C shows a modified hook of FIG. 1 to more clearly indicate to the user whether the objects hung is overweight or not. The modified hook 10 further comprises a weight watcher 82 having a mark plate 48 with marks 56. The mark plate has an opening 44 for the user to see from the top the pointer 49 on the distributor 95. Just for the purpose of showing various holders, the holder 34 here is a simple round protrusion 47 on the extension beam 32 to prevent the object from falling off the holder. A recession 49 is formed on the extension beam 32 to indicate where to hang the object for consistent weight measurement by the weight watcher 82.

The attachment member 30 is replaced by a pressure sensitive adhesive 45 on the back surface of the base plate. The distribution plate 22 is sufficiently deformable to contact the front surface of the base plate 21 when the distributor is pressed towards the base plate. This facilitates the adhesion of the base plate to the support surface by the adhesive 45. After the hook is attached to the support wall and when an object is hung at recession 49 of the holder 34, the object's weight causes the distribution plate 22 to bend towards the right a predetermined degree or distance and thus the pointer 49 points to the mark 56 on the mark plate corresponding to the weight of the object. For example, if the object is 51 lbs., the distribution plate will move or bend to allow the pointer 49 to align with the mark “5” on the mark plate.

The modified hook shown in FIG. 4 is similar to that of FIG. 3 except the different mechanism for the weight watcher 82. The modified weight watcher comprises a lower distribution plate 22B, a upper distribution plate 22A having a chamber 50 to receive the lower distribution plate 22B, a spring 51 to support the upper plate 22A on the lower plate 22B, and a red color mark 52 on the front face of the base plate 21. During use, an object of a certain weight on the holder 34 pulls the holder, thus the upper distribution plate 22A, downward to compress the spring 51. As a result, the pointer 49 moves downward a predetermined distance and expose the red color mark 52 if the object has weight over the limit allowed by the hook 10.

The modified hook 10 shown in FIG. 5 is also similar to that of FIGS. 3 and 3A except the different mechanism for the weight watcher 82. This modified weight watcher comprises a first (or left) arc-shaped and a second (or right) arc-shaped distribution plates or beams 94, a mark 48 with marks 56 formed near the center of the base plate 21. The first and second beams or plates have the same or at least similar shape, dimension and strength to enable the holder 34 to move substantially vertically when an object of sufficient weight is placed on the holder. The holder 34 is connected to the upper end of the left and right deformable beams or plates to facilitate the response of the weight watcher 82 to the object. After the hook is attached to the wall and when an object is hung on the holder 34, the object's weight deforms the left and right beams 94 and causes the point 49 to move downward to point to the mark corresponding to the weight of the object.

It is appreciated that the weight watcher 82 may further comprises a switch (not shown) adapted to be turned on by the beam or plate 94 that is deformed a predetermined degree by an object of a certain weight. The switch controls a device that may generate a color, a sound and an electric light to indicate to the user whether the weight of the object surpasses the limit of the hook. It is also appreciated that the deformable member such as the plate or beam 94 may comprise a piezoelectric element or color changing element (not shown) to produce a signal to indicate the weight of the object on the hook.

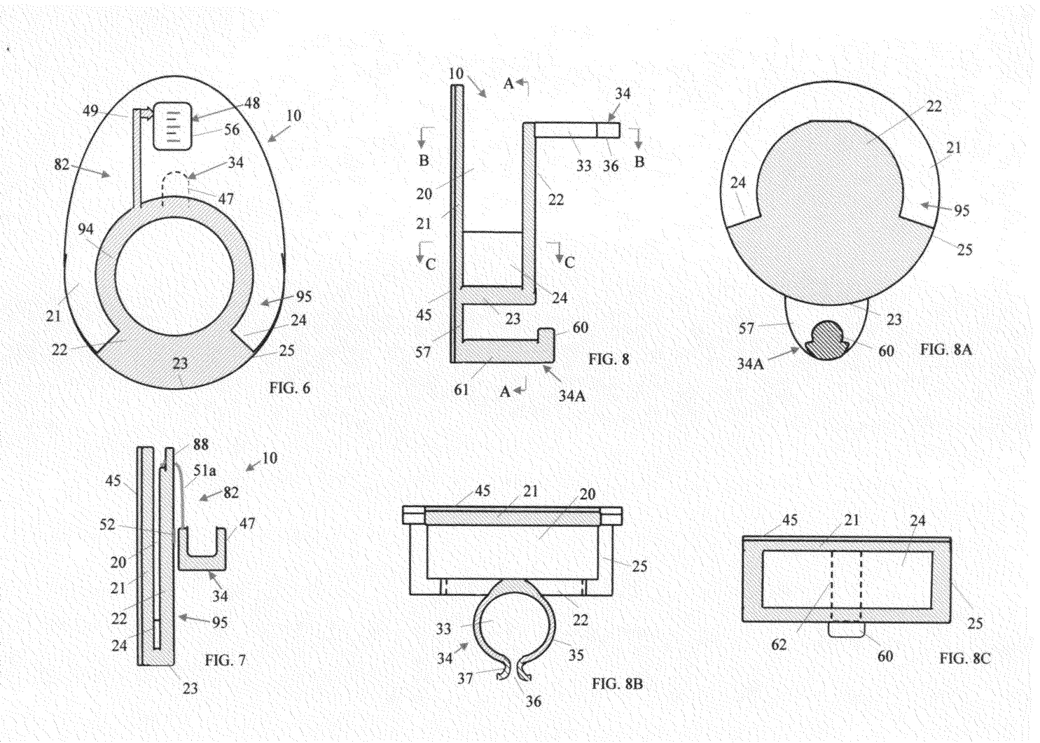

The modified hook 10 shown in FIG. 6 is similar to that of FIG. 10 except that the base plate 21 is oval shape and marks 56 and pointer 49 are positioned above the holder 34. This modified design prevents the object from blocking the marks 56 and makes it easier for the user to read the weight. It is appreciated that the holder may comprises a vertical extension beam (not shown) having an upper end connected to the top end of the left and right distribution beams 94 and a lower end connected to the holder 34. The lower end of the vertical beam can be positioned below the center of the distribution beams 94 so that the holder and the object can be near the lower part of the left and right distribution beams 94.

The modified hook shown in FIG. 7 is also similar to that of FIGS. 3 and 4 except the different mechanism for the weight watcher 82. This modified weight watcher comprises an elastic strip or rope 51a that has one end attached to the top end 88 or other part of the distribution plate 22 and the lower end attached to the holder 34 and a mark 52. After the hook is attached to the wall and when an object is hung on the holder 34, the object's weight stretches the elastic strip 51a and causes the holder 34 to move downward to expose the mark 52 if the object is over a certain weight. There can be graduated weight marks for the mark 52 to indicate the weight of the object hung on the holder 34.

FIGS. 8-8C shows a modified hook of FIG. 1. Compared to the hook of FIG. 1, the modified hook has a substantially wider space 20 and chamber 24, has an additional holder 34A with a specially shaped protrusion 60, and a pressure sensitive adhesive layer 45 to replace the attachment member 30. The wider chamber 24, defined by the base plate 21, the distribution plate 22, and a left and a right side walls 25, allows the hook to receive or hang objects such as spoons, knives and phones that do not have a through hole or loop to fit to a conventional hook. The additional holder 34A is connected to a downward extension 57 of the base plate 21, and comprises an outwardly protruded beam 61 and upward protrusion 60 to hang additional objects. Being positioned below the wider chamber 24, the object hung on holder 34 is protected from being knocked off the holder accidentally.

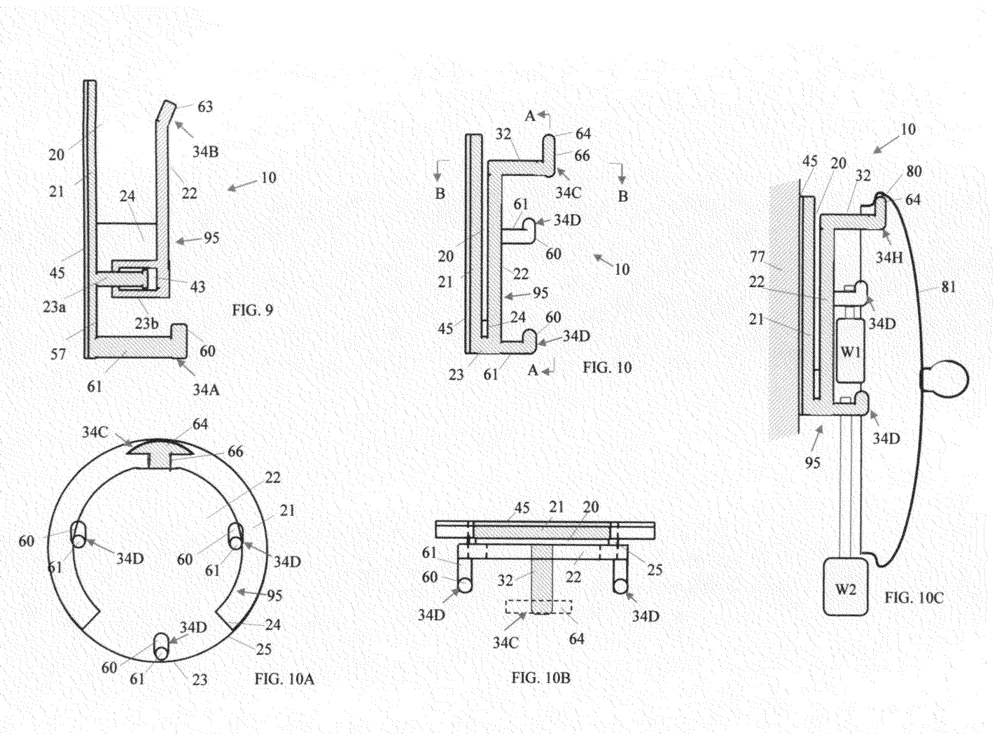

FIG. 9 shows a modified hook of FIG. 8. Compared to the hook of FIG. 8, the modified hook comprises a new expandable chamber 24 and space 20 and a new holder 34B that has a simple arc-shaped outwardly tilted plate 63 formed at the top end of the distribution plate 22. The tilted plate 63 is much wider than a conventional hook and fits perfectly into the annual recess 80 for large objects such as a lid 81 shown in FIG. 10C that do not have a through hole. The protrusion 60 here is similar to that of FIG. 8 and has the shape of the distributor to show the user that both holder 34A at the bottom end of the base plate 21 and the holder 34B at the top end of the distribution plate 22 are for hanging objects.

The bottom wall 23 and side wall 25 are both expandable to allow the chamber 24 and space 20 to expand when a larger object is to be received in the chamber 24. The bottom wall 23 has a first bottom wall 23a connected to the base plate 21 and receivable in the chamber 43 of the second bottom wall 23b connected to the plate 22. The expandable side wall 25 has similar structure. When the object is large, one may pull the plate 22 out or to the right to expand the chamber 24 and space 20. It is appreciated that the first bottom wall 23a can be formed on the plate 22 and the second bottom wall 23b with chamber 43 can be formed on the base plate 21. It is also appreciated that a plate-, beam-, wire- or coil-shaped spring (not shown) may be connected between the base plate 21 and the plate 22 to keep the chamber 24 in a narrower or non-expanded position when no or a thin object is placed in the chamber and to clamp the object when a thicker object is placed into the chamber.

FIG. 10 shows another modified hook of FIG. 1. The holder 34C of the modified hook 10 has an arc-shaped top plate 64 connected to the extension beam 32 via a beam 66 for hanging large objects such as lid 81 shown in FIG. 10C that do not have through holes. A pressure sensitive adhesive layer 45 is used here to replace the attachment member 30 of FIG. 1. The modified hook also has three additional holders 34D attached to the left, right and bottom of the distribution plate 22. Each of the additional holder 34D has a protrusion 60 connected to the distribution plate 22 by a beam 61. Unlike like traditional hooks, the new hook can hang 3 to 4 objects (FIG. 10C) without the object contacting or interfering with each other. said distributor comprises at least one of a first plate and beam, a thin gap between said base plate and said at least one of first plate and beam, and at least one of a second and beam having one end connected to said at least one of first plate and beam and the other end extending at an angle a predetermined distance away from said at least one of first plate and beam, said at least one of first plate and beam being sufficiently vertical and said gap being sufficiently thin to prevent the object from disengaging said back surface from the support surface.

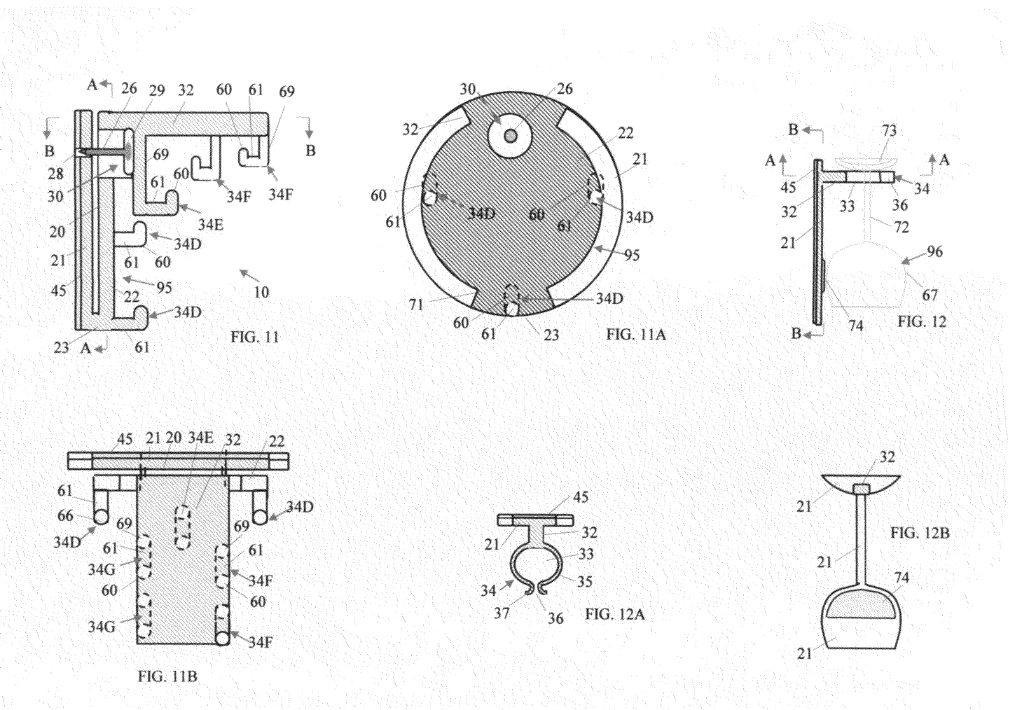

FIG. 11 shows a modified hook of FIG. 10. Unlike in the hook of FIG. 10 the holder 34C is located above the extension beam 32, in this modified hook numerous holders are located below an extension plate 32 to hang objects there below. An additional attachment member 30, which is the same as that in FIG. 1, is included to strengthen the attachment to the support wall. There are a left row of holders 34G, a center row of holder 34E, and a right row of holders 34F connected to the under surface of the extension plate 32. Each of the holders 34E, 34F and 34G has a sufficiently horizontal beam 61, a protrusion 60 at the first end of the holder to receive the object to be hung or prevent the object from failing off the hook, and a beam 69 at the second end of the holder to connect the holder to the underside of the extension plate 32. Except the holder 34E of the center row, all of holders 34F and G are so constructed that the first end of the holder is located closer to the base plate than the second end of the holder, thereby preventing the object on the first end from being knocked off the holder accidentally. It is appreciated that the holders on the right row are un-aligned with the holder(s) on the left row, e.g. the front holder 34F on the right row is a certain distance closer to the front end of the extension plate 32 than the front holder 34G on the left row (FIG. 11B), to enable large objects such as lids to hang on both the left and right rows of holders. It is also appreciated that the extension plate 32, with one end connected to the base plate 21 through the distribution plate 22 and the other end extending a predetermined distance away from the base plate, may extend out at any angle such as 60 and 120 degrees, besides the right angle shown in FIG. 11, relative to the base plate.

FIG. 12 shows another modified hook of FIG. 1. In this modified hook 10, the base plate 21 has substantially the shape of a wine glass hung on the holder 34 (FIGS. 12 and 12B) to indicate and facilitate the use and mounting of the hook to the support surface. The holder 34 is connected via the extension beam 32 directly to the base plate 21, which is to be attached to a support wall via adhesive layer 45. A pad of material 74 of a predetermined shape and wine color is attached to a predetermined location on the front face of the base plate to contact the wine receiving chamber 67 of the wine glass 96. This material pad 74 is substantially softer than said base plate to reduce or prevent the movement of the wine glass on the hook. Both the upper and lower surfaces of the holder 34 are able to receive the bottom base 21 and the wine containing chamber 67 of the wine glass. This enables the hook to be mounted to the support surface either in upside down position as shown in FIGS. 12 and 12B in which the pad 74 is below the extension beam 32 and holder 34 or in a standup position (not shown) in which the pad 74 is above the extension beam 32 and holder 34.

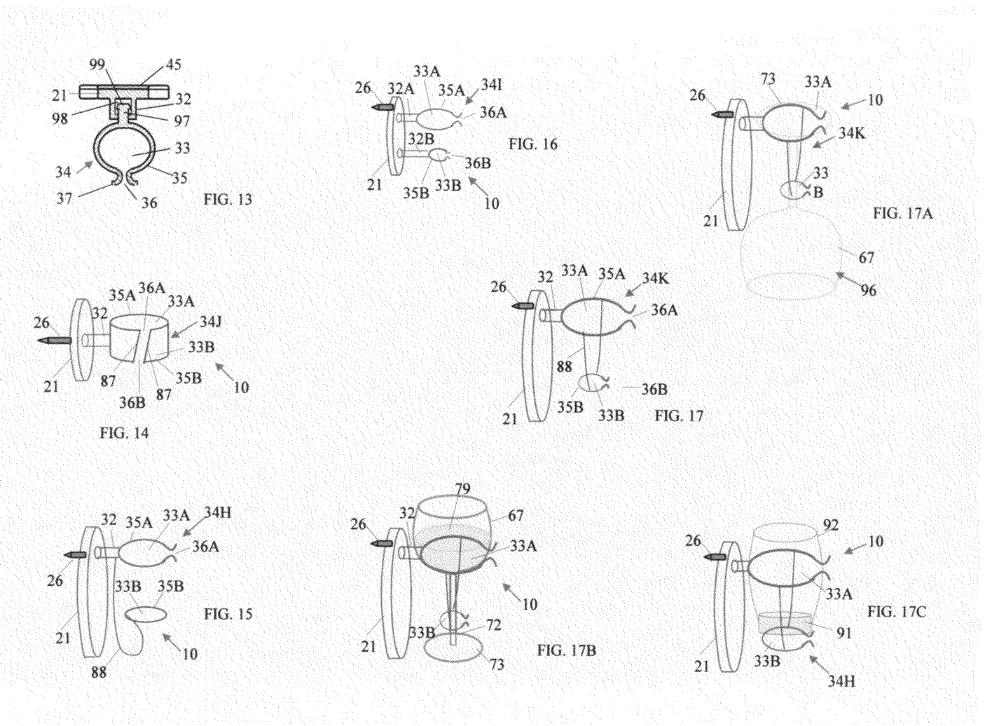

It appreciated that the extension beam 32 of the modified hook of FIG. 12 can be made expandable to enable the holder 34 to extend farther away from the base plate 21 when the wine glass is large and to be pushed in when the wine glass is small (FIG. 13). The extension beam 32 in FIG. 13 comprises a inner beam 97 with one end connected to holder 34, a head 99 at the other end of the inner beam, and an extension chamber 99 having a neck to receive the inner beam 97 frictionally and prevent the inner beam from being disconnected or completely pulled out of the chamber. When a large wine glass is to be hung, one pulls the holder 34 to pull the inner beam 97 out of the extension chamber frictionally so that the wine glass can hang substantially vertically. It is also appreciated that when the hook is mounted in either the standup or upside down position, the wine glass 96 can be held by the holder 34 in the standup (possibly with wine in it) and upside down positions. It is also appreciated that a distributor 95 having a distribution plate 22 and a gap 20 (not shown) may be included in this modified hook 10 to prevent any possible fall-off of the hook from the support wall. It is further appreciated that a weight watcher 82 may be included in this modified hook (not shown) to indicate the weight of the wine glass or wine held by the hook.

A modified version of the hook 10 in FIG. 12 is shown in FIG. 14, which has a new holder 34J that is connected to the base 21 by an extension beam 32 and comprises a first opening 33A formed by a top ring 35A to receive the stem 72 and part of the wine containing chamber 67 or wine glass base 73, a second opening 36A on the top ring 35A to allow the stem 72 to pass through, a third opening 33B formed by a bottom ring 35B, and a forth opening 36B to allow the stem 72 to pass through and into the third opening 33B. The second and forth openings are mis-aligned, i.e. the connection lines 87 between the two openings are tilted, in such a way that the stem 72 cannot move out of the first and third openings vertically, thereby further preventing the wine glass from falling off said hook. (Note: The wine glass normally sits in the first opening vertically. The mis-aligned second and forth opening require the wine glass to tilt at a predetermined angle to move out of the first and third openings, which is mostly unlikely to occur naturally.) The hook is attached to the support wall by a sharp member 26 connected to the base plate 21. It is appreciated that the third opening 33B at the bottom of the holder can be substantially smaller (not shown), such as 5 times smaller, than the first opening 33A, and the third opening is preferably only slightly larger, such as 50% larger, than the diameter of the stem 72 for the wine glass to by hung or held. The small third opening 33B helps stabilizing the wine glass received in the first opening.

A modified version of the hook 10 in FIG. 14 is shown in FIG. 15, which has a new holder 34H that is connected to the base 21 by an extension beam 32 and comprises a first opening 33A formed by a top ring 35A, a second opening 36A on the top ring to allow the stem 72 to pass through, and a third opening 33B formed by a bottom ring 35B and connected to the top ring by a rigid or semi-rigid beam or wire 88.

Another modified version of the hook 10 in FIG. 14 is shown in FIG. 16, which has a new holder 341 that comprises a first opening 33A formed by a top ring 35A and connected to the base 21 by a top extension beam 32A, a second opening 36A on the top ring to allow the stem 72 of the wine glass to pass through, a third opening 33B formed by a bottom ring 35B and connected to the base plate 21 by a lower extension beam 32B, and a forth opening 36B on the bottom ring to allow the stem 72 of the wine glass to pass through and into the third opening 33B. The third opening 33B is much smaller, such as 2 to 10 times smaller, than the first opening 33A to help stabilizing the wine glass received in the first opening.

A modified version of the hook 10 in FIG. 16 is shown in FIG. 17, where the third opening 33B or the bottom ring 35B of the holder 34K is connected to the first opening 33A or the top ring 35A by two opposing rigid or semi-rigid beams or wires 88. FIG. 17A shows a wine glass is hung upside down on the hook with the bottom base 73 of the wine glass supported by the 1^{st} opening 33A and the stem 72 received and restricted by the third opening 33B to stabilize the wine glass. FIG. 17B shows a wine glass containing wine in its standing position and with its wine containing chamber supported by the first opening 33B and the stem 72 received and restricted by the third opening 33B. FIG. 17C shows a juice glass 92 with its top part received by the first opening 33A and its bottom 91 supported by the third opening 33B or bottom ring 35B.

Clearly, the modifications for the hook can be combined into or removed from any of the exemplar embodiments of the invention. The scope of the invention is obviously not restricted to the embodiments described by way of examples and depicted in the drawings, there being numerous changes, modifications, additions, and applications thereof imaginable within the purview of the claims.

What is claimed is:

1. A hook for hanging an object to a support surface such as a wall comprising:
a base plate having a front surface facing an object to be hung and a back surface for engagement with a support surface;
a distributor for distributing the force produced by the weight of the object over said base plate to minimize the risk of disengagement between said base plate and the support surface as a result of the object's weight;
a holder having a first end for holding the object and a second end connected to said distributor; and
wherein said distributor is connected to a predetermined location at or near the lower part of said base plate.

2. A hook as defined in claim 1 wherein said distributor comprises a deformable member adapted to deform or move to provide a signal in response to the weight of the object on said holder.

3. A hook as defined in claim 2 wherein said signal includes at least one of a movement of a pointer, a change of color, a sound and an electric light.

4. A hook as defined in claim 1 further comprises a gap between said distributor and base plate, said gap being sufficiently thin to prevent the object from entering said gap.

5. A hook as defined in claim 1 further comprising a pressure sensitive adhesive on said back surface of said base plate, wherein said distributor is sufficiently deformable to contact said front surface of said base plate when said distributor is pressed towards said base plate, thereby facilitating the adhesion of said base plate to the support surface.

6. A hook as defined in claim 1 wherein said holder further comprises at said first end a first opening to receive the stem of a wine glass and a second opening to allow the stem of the wine glass to enter said first opening, said first opening being substantially larger than the stem but smaller than at least one of the base and containing chamber of the wine glass, said second opening being smaller than the stem to prevent the wine glass from falling out but sufficiently expandable to enable the stem to be pushed into said first opening by force.

7. A hook as defined in claim 6 wherein said distributor comprises a lower end connected to said base plate at said predetermined location and an upper end separate from said base plate and positioned near or above the center of said base plate, said second end of said holder being connected to said distributor at or near said upper end, thereby saving storage space below said hook by increasing the distance between the wine glass and the bottom end of the support surface.

8. A hook as defined in claim 1 further comprises an opening on said base plate, a sharp member receivable by said opening to attach said base plate to the support surface, and a track on at least one of said distributor and base plate to hold said sharp member in place and guide the penetration of the support surface by said sharp member.

9. A hook as defined in claim 1 further comprises a chamber for holding an object that may not have a hole to fit to a conventional hook, said chamber being defined by said base plate, said distributor, and a left and a right side walls between said base plate and distributor.

10. A hook as defined in claim 9 wherein said holder comprises an upward extension of said distributor above said chamber, said extension being receivable in a recess near the edge of a lid, thereby causing the lid to hang over said extension of said hook.

11. A hook as defined in claim 9 further comprising a downward extension of said base plate and an outward protrusion on said downward extension for hanging an object, said chamber being above protrusion to prevent the object from being knocked off said protrusion accidentally.

12. A hook as defined in claim 9 wherein said chamber is expandable.

13. A hook as defined in claim 12 wherein said chamber further comprises at least of a plate-shaped, beam-shaped, wire-shaped and coil-shaped springs connected to said base plate and said distributor to clamp the object therein.

14. A hook as defined in claim 1 wherein said distributor comprises at least one of a plate and beam having one end connected to said base plate and the other end extending at an angle a predetermined distance away from said base plate, wherein said second end of said holder is connected to the undersurface of said at least one of plate and beam.

15. A hook as defined in claim 14 further comprising at least one additional holder connected to said undersurface of said at least one of plate and beam.

16. A hook as defined in claim 14 further comprising a left row and a right row of holders connected to said undersurface of plate or beam, wherein said holder(s) on said right row are un-aligned with said holder(s) on said left row.

17. A hook as defined in claim 14 wherein said first end of said holder is located substantially closer to said base plate than said second end of said holder is, thereby preventing the object on said first end of said holder from being knocked off said holder accidentally.

18. A hook as defined in claim 1 wherein said distributor comprises at least one of a first plate and beam, a thin gap between said base plate and said at least one of first plate and beam, and at least one of a second and beam having one end connected to said at least one of first plate and beam and the other end extending at an angle a predetermined distance away from said at least one of first plate and beam, said at least one of first plate and beam being sufficiently vertical and said gap being sufficiently thin to prevent the object from disengaging said back surface from the support surface.

19. A hook as defined in claim 1 wherein said distributor comprises at least one of a plate and beam, a sufficiently thin space between said distributor and base plate to prevent the object from disengaging said back surface from the support surface, and a second holder having one end for holding a second object and the other end connected to said distributor, thereby allowing said hook to hold or hang a plurality of objects.

20. A hook for hanging an object to a support surface such as a wall comprising:
a base plate having a front surface facing an object to be hung to a support surface and a back surface for engagement with the support surface;
a holder having a first end for holding the object and a second end; and
a weight watcher connected to said base plate and said second end of sad holder, said watcher comprising a deformable member adapted to provide the user a signal in response to the weight of the object on said holder.

21. A hook as defined in claim 20 wherein said deformable member is adapted to deform or move a predetermined degree or distance when an object of certain weight is placed on said holder, wherein said weight watcher further comprises a mark to indicate to the user said deformation or movement for said deformable member.

22. A hook as defined in claim 21 wherein said deformable member comprises at least one of a plate, spring and beam.

23. A hook as defined in claim 21 wherein at least part of said mark is located above said holder.

24. A hook as defined in claim 21 wherein said deformable member comprises one of a first beam and plate having one end connected to said base plate and another end connected to said second end of said holder and one of a second beam and plate having one end connected to said base plate and another end connected to said second end of said holder, wherein said one of first beam and plate and said one of second beam and plate are adapted to corporate to enable said holder to move substantially vertically when an object of sufficient weight is placed on said holder.

25. A hook device as defined in claim 20 further comprising a switch for controlling said signal, said switch being adapted to be turned on by said deformable member.

26. A hook device as defined in claim 20 further comprising a gap between said weight watcher and base plate, said gap being sufficiently thin to minimize the risk of disengagement between said base plate and the support surface by the object.

27. A hook device as defined in claim 26 wherein said weight watcher is connected to the lower part of said base plate and extends upwards to form said sufficiently thin gap.

28. A hook device as defined in claim 20 wherein said second end of said holder is connected to a predetermined location on said weight watcher, said location being sufficiently close to the upper part of said deformable member to facilitate the response of said weight watcher to the weight of the object.

29. A hook as defined in claim 20 wherein said deformable member comprises one of a piezoelectric element, a color changing element, a light generator and a sound generator.

28. A hook for hanging an object to a support surface such as a wall comprising:
a base plate having a front surface facing an object to be hung and a back surface for engagement with a support surface;
a holder having a first end for holding a wine glass and a second end connected to said base plate;
an extender between said second end and base plate to prevent the wine glass from contacting the hard support surface; and
wherein said holder further comprises at said first end a first opening to receive the stem of the wine glass and a second opening to allow the stem of the wine glass to enter said first opening, said first opening being substantially larger than the stem but smaller than at least one of the bottom and wine containing chamber of the wine glass, said second opening being smaller than the stem to prevent the wine glass from falling out but sufficiently expandable to enable the stem to be pushed into said first opening manually.

29. A hook as defined in claim 28 further comprising a distributor connected between said base plate and extender, said distributor having one of a plate and beam, a gap between said base plate and said one of plate or beam, and an upper part connected to said extender.

30. A hook as defined in claim 28 wherein said extender is expandable to enable said holder to extend farther away from said base plate when the wine glass is large.

31. A hook as defined in claim 28 wherein said base plate adapts substantially the shape of a wine glass to be held on said hook to facilitate the mounting and use of said hook to the support surface.

32. A hook as defined in claim 28 wherein said first opening is smaller than both the bottom base and the wine containing chamber of the wine glass, thereby allowing said hook to hold the wine glass in both a standup position capable of hold wine in the chamber and an upside down position.

33. A hook as defined in claim 28 wherein said holder further comprises a third opening located below said first opening and adapted to stabilize the wine glass received in said first opening.

34. A hook as defined in claim 33 wherein said holder further comprises a forth opening for said third opening, said forth opening being adapted to allow the stem of the wine glass to enter and to be received in said third opening.

35. A hook as defined in claim 33 wherein said second and forth openings are mis-aligned in such a way that the stem cannot move out of said first and third openings vertically, thereby further preventing the wine glass from falling off said hook.

36. A hook as defined in claim 33 wherein said third opening of said holder is substantially smaller than said first opening.

37. A hook as defined in claim 28 further comprising a sheet of materials of a predetermined shape connected a predetermined location on said base plate to contact the wine receiving chamber of the wine glass, said sheet of materials being substantially softer than said base plate.

38. A hook as defined in claim 28 wherein both the upper and lower surfaces of said holder are adapted to receive at least one of the bottom base and the wine containing chamber of the wine glass, thereby enabling said hook to be mounted to the support surface either in a standup position or upside down position.
